(19) United States
(12) Patent Application Publication
(10) Pub. No.: US 2003/0120813 A1
(43) Pub. Date: Jun. 26, 2003

(54) Apparatus and method for optimizing message sizes of textual protocols used in multimedia communications

(76) Inventors: Ishita Majumdar, Schaumburg, IL (US); Richard Jun La, Gaithersburg, MD (US); Rajeev Agrawal, Northbrook, IL (US)

Correspondence Address: MOTOROLA, INC., 1303 EAST ALGONQUIN ROAD, IL01/3RD, SCHAUMBURG, IL, 60196

(21) Appl. No.: 10/027,398

(22) Filed: Dec. 21, 2001

(51) Int. Cl. G06F 15/16

(52) U.S. Cl. 709/247; 709/206

(57) ABSTRACT

An apparatus and method for generating compressed SIP messages from full sized SIP messages and vice versa in order to decrease call set up time in an IP based communication system. During registration of a device, the invention caches the device's static information in the core network in a “Registrar/Location Server.” Subsequently, during call set up, the device transmits its dynamic information to the SIP Agent in a compressed SIP message over an air interface. The SIP Agent retrieves the static information (from the Registrar/Location Server) along with the dynamic information in the compressed SIP message to generate a full sized SIP message. The SIP Agent forwards the full sized SIP message to a SIP Proxy, which is then transmitted to the IP system. Likewise, when a full sized SIP message is received from the IP system, the message is forwarded to the SIP Agent to generate a compressed SIP message for ultimate transmission to the device over the air interface.

### FIELD OF THE INVENTION

The present invention relates generally to the field of communication systems, and more particularly, to an apparatus and method for optimizing message sizes of textual protocols (e.g. SIP) used in multimedia communications.

### BACKGROUND OF THE INVENTION

Currently, telephony service is provided for the most part over circuit switched networks. A fast emerging new trend called IP telephony provides telephony service over Internet Protocol (IP) networks. The motivating factors for carrying voice traffic over data networks are the integration of voice and data applications, which can result in more effective business process, cost savings for voice calls and enabling of many new services for business and customers. The flexibility offered by IP telephony lies in moving the intelligence from the network to the end stations, thereby enabling many new services that did not exist before. In an effort to merge Internet and cellular telephony, two aspects are focused on—end-to-end call set up delay and voice quality.

The Session Initiation Protocol (SIP) is an application layer control (signaling) protocol for creating, modifying and terminating sessions with one or more participants. These sessions include Internet multimedia conferences, Internet telephone calls and multimedia distribution. The use of SIP in setting up cellular calls causes enormous delays in setting up a network connection. The delay results mainly due to the size of the SIP messages transmitted over the air. The size of the SIP messages comprising a call sequence is much larger than the typical layer 3 message size in cellular calls. A bulk of the latency is due to air transmission delay. For CDMA 2000, for example, the basic channel supports only 9.6 kbps. At this rate, transmission of each byte requires 0.8 ms. A typical call set up sequence requires the transmission of multiple SIP messages averaging 400 bytes in size. The average call set up delay for a Mobile to Mobile call is approximately 8-10 seconds. Therefore, in order to reduce call set up delay, there is a need for an apparatus and method for optimizing message sizes of textual protocols (e.g. SIP) used in multimedia communications.

### BRIEF DESCRIPTION OF THE DRAWINGS

FIG. 1 is a block diagram of a network architecture that can be used to implement the apparatus and method of the present invention.

FIG. 2 is a flowchart of the preferred method of generating compressed SIP messages and full SIP messages in a mobile station.

FIG. 3 is an example of a SIP Register message used to illustrate the method of the present invention.

FIG. 4 is an example of the framework for static and default dictionaries created from information in a SIP Register message.

FIG. 5 is an example of static and default dictionaries created from the information in the SIP Register message of FIG. 3.

FIG. 6 is a flowchart of the preferred method of generating a full SIP message from a compressed SIP message in the SIP Agent of FIG. 1.

FIG. 7 is an example of a full SIP INVITE message used to illustrate the method of the present invention.

FIG. 8 is an example of a compressed SIP INVITE message used to illustrate the method of the present invention.

FIG. 9 is a flowchart of the preferred method of generating a compressed SIP message from a full SIP message in the SIP Agent of FIG. 1.

FIG. 10 is an example list of Request and Response messages that can be used with the present invention.

### DETAILED DESCRIPTION OF THE DRAWINGS

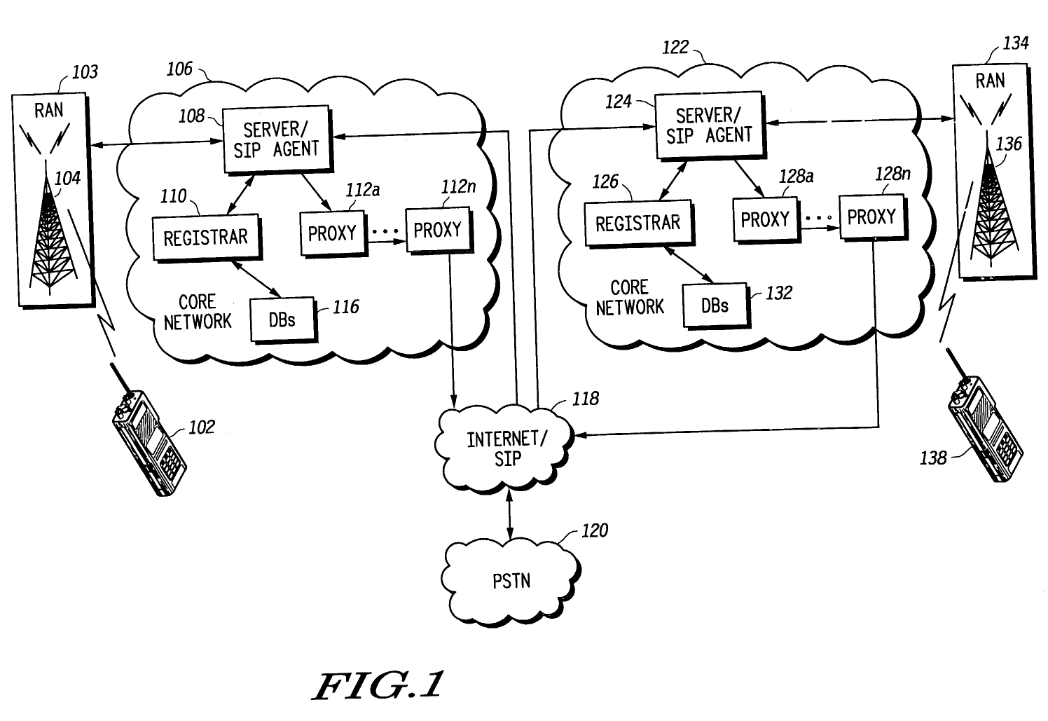

The present invention provides an apparatus and method for reducing call setup delay associated with transmitting SIP messages over an air interface to establish voice and data sessions over an IP network. Referring to FIG. 1, a block diagram of a system architecture that can be used with the preferred embodiment of the apparatus and method of the present invention is shown. The preferred embodiment of the present invention is described with reference to MSs 102 and 138. It should be understood that the invention can also be used with a host of other devices such as a personal computer (PC), a pager, a personal digital assistant (PDA), or wireless adapter devices (e.g., wireless modems adapted for coupling with computers, message pads, etc.), and the like.

In FIG. 1, a MS 102 transmits SIP call set up messages to a Base Transceiver Station (BTS) 104 in a Radio Access Network (RAN) 103 over a dedicated RF traffic channel (air interface). Transmitting SIP messages over the air interface can result in significant delays. In accordance with the preferred embodiment of the present invention, the MS 102 generates a compressed SIP message for transmission over the air interface to a new element called a “SIP Agent” 108 in a Core Network (CN) 106. In the preferred embodiment, the SIP Agent 108 is a separate entity from the Proxy 112. In an alternate embodiment, the SIP Agent 108 can be physically separate from the Core Network as a distinct entity.

Upon receipt of the uplink communication, the SIP Agent 108 generates a full SIP message from the compressed message and forwards the message to a Proxy 112 for routing to the Internet 118 in accordance with the procedures described in Section 12.3 of Request For Comment 2543 (RFC: SIP: Session Initiation Protocol). As shown in FIG. 1, the full SIP message may travel through several Proxies 112a . . . 112n before reaching the Internet 118. From the Internet 118, the full SIP message may be sent to the Public Switch Telephone Network (PSTN) 120 for ultimate transmission to a landline device or it may be sent to a second CN 122 for ultimate transmission to another MS 138. As shown in FIG. 1, the configuration of the CN 122, RAN 134 and MS 138 is a mirror image of the configuration already described. A full SIP message received in the CN 122 is converted into a compressed SIP message by the SIP Agent 124 to decrease transmission time when it is transmitted over the air interface from the BTS 136 to the MS 136.

The SIP Agent 108 (124) forwards Register messages received from the MS 102 (138) to a SIP server that functions as a Registrar 110 (126). The Registrar 110 (126) stores (caches) the Registration information in a local contact database 116 (132) as defined in RFC 2543. When the SIP Agent 108 (124) receives compressed call set up messages that need to be translated to full call setup messages and vice versa, it looks at the “From” or “To” URL in the message and requests the cached information from the Registrar 110 (126) serving the identified domain. The “SIP Agent” 108 (124) uses the information to populate the empty static and default dictionaries shown in FIG. 4. The static dictionary contains information in the Register message that remains constant throughout the session (until the MS reregisters). The default dictionary contains default values for parameters in the Register message.

The “SIP Agent” 108 (124) must also determine whether a received message is a Request message or a Response message. In a first embodiment, the Agent 108 (124) accesses a Request list and a Response list as shown in FIG. 10. Request messages are non numeric and contain a field called a “method” (i.e., INVITE, ACK, OPTIONS, etc). Response messages include a numeric prefix. In the first embodiment, the Agent 108 (124) compares a received message to those listed in FIG. 10 to determine whether the message is a Request or a Response. In an alternate embodiment, the Agent 108 (124) may determine that any non-numeric message is a Request and any message having a numeric prefix is a Response.

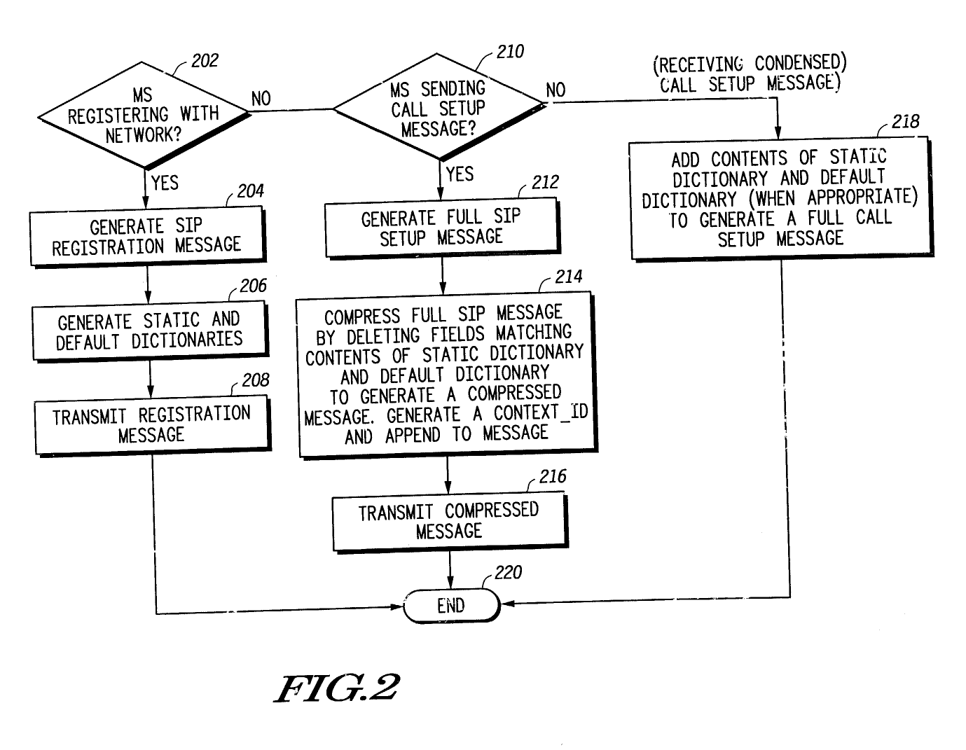

Details of the preferred embodiment of the present invention will now be provided with reference to FIGS. 2-9. Before a MS 102 (138) can establish a session, it must register with a network. In FIG. 1, MS 102 registers with CN 106 and MS 138 registers with CN 122. Referring to the flowchart of FIG. 2, the method in the MS 102 (138) determines that the MS 102 (138) needs to register (step 202). At step 204, the MS 102 (138) generates a SIP Register Message. In particular, the SIP stack in the MS 102 (138) generates a full SIP Register Message containing information such as default and full media capability, IP address, host name and codec options. (In most cases the capability information is sent by the user during Registration when the Registrar queries it with an Options message.)

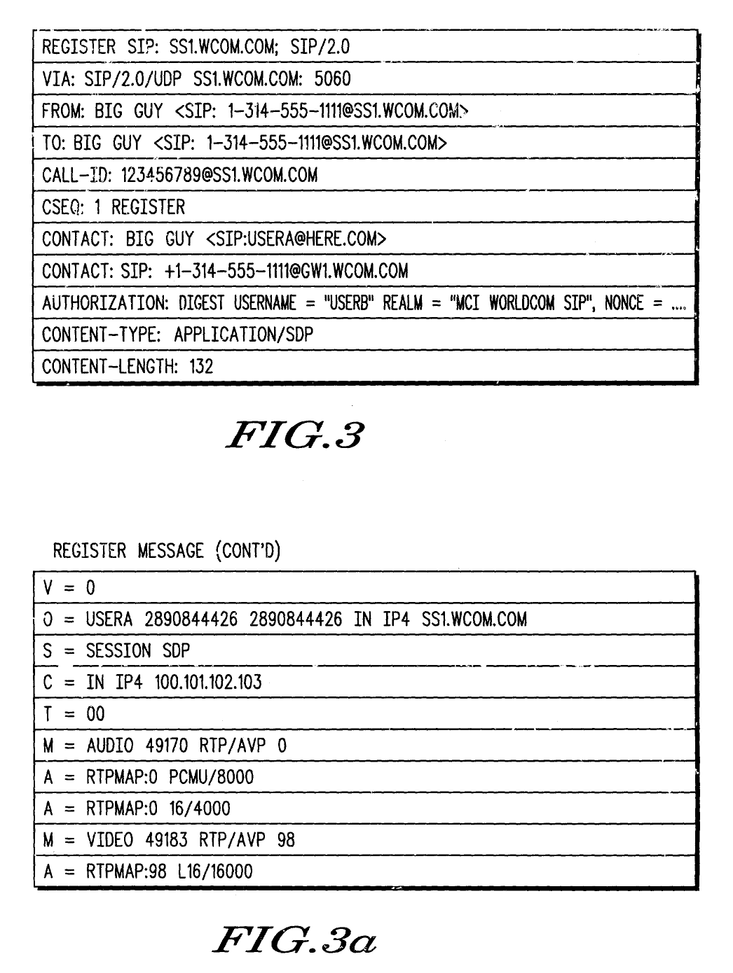

An example of a Register message is shown in FIG. 3. The Register message contains a header section (SIP header with contents) and a body section. The body section is separated from the header section by an empty line. The message body carried by a SIP message is usually a session description. The first line of the header includes the method name (REGISTER) and the host URL “ss1.wcom.com.” “SIP/2.0” states that SIP version 2.0 is used. In the “Via” field, “5060” is the port number where the host expects to receive a response to its message. In the “From” field, Big Guy (e.g. MS 102) is registering and has a mobile telephone number 1-314-555-1111@ss1.wcom.com. In the “Call-ID” field, “123456789” uniquely identifies the message. The “Cseq” field contains the request method (REGISTER) and a single decimal sequence number (1) chosen by the requesting client (MS 102). Sequence number 1 means that the REGISTER message is sent for the first time. The “Contact” field specifies how the user (Big Guy) can be contacted. Here, Big Guy can be contacted two ways. The first Contact field states that Big Guy can be contacted via email at UserA@here.com. The second Contact field states that the user can be contacted at SIP telephone number (landline number) 1-314-555-1234@gw1.wcom.com, which looks like an email address. The Authorization field contains information used to prove that User A is a legal user of the system. The “digest realm” and “domain” inform the proxy server of User A's identity. The nonce which is a unique value shared by the User and the server. Usually, authentication information is sent by a User when challenged by a server. The “Content-Type” field specifies the media type of the message body, which in the current example is a protocol called Session Description Protocol (SDP). The “Content-Length” field indicates the size of the message body in bytes.

The remainder of the REGISTER message, shown in FIG. 3A, is the body of the message. The “v” field designates the version of the media type. In the current example, the version of the SDP is 0. The “o” field specifies the user name (User A), the session id (2890844526), the version number (2890844526), the network type (IN (Internet)), the address type (IP4 (IP version 4)) and the globally unique address of the device from which the session is created. The “s” field specifies the session name. The “c” field means connection data. This field specifies the network type and the address of the sender. In the current example, the network type is Internet and the address of the sender is 100.101.102.103 (address type IP4). The “t” field specifies the start and stop times for a conference session. In the current example 0.0 is a time representing that the call should start immediately. The first “m” field specifies that the sender/caller can receive audio packets on port 49170 where RTP/AVP is the transport protocol and 0 is the payload type, which is u-law Pulse Code Modulated (PCM) coded single channel audio. Two codec options are specified for the audio capability. In the first “a” field, a PCMU codec is specified. 8000″ is the clock rate (number of times per second that audio is fetched). In the second “a” field, an 16 codec and a 4000 bit/sec clock rate is specified. The second “m” field specifies that the sender/caller can receive video packets on port 49183 where “98” is the payload type. The “a” field corresponding to the video capability specifies an L16 codec and a 16000 bit/sec clock rate.

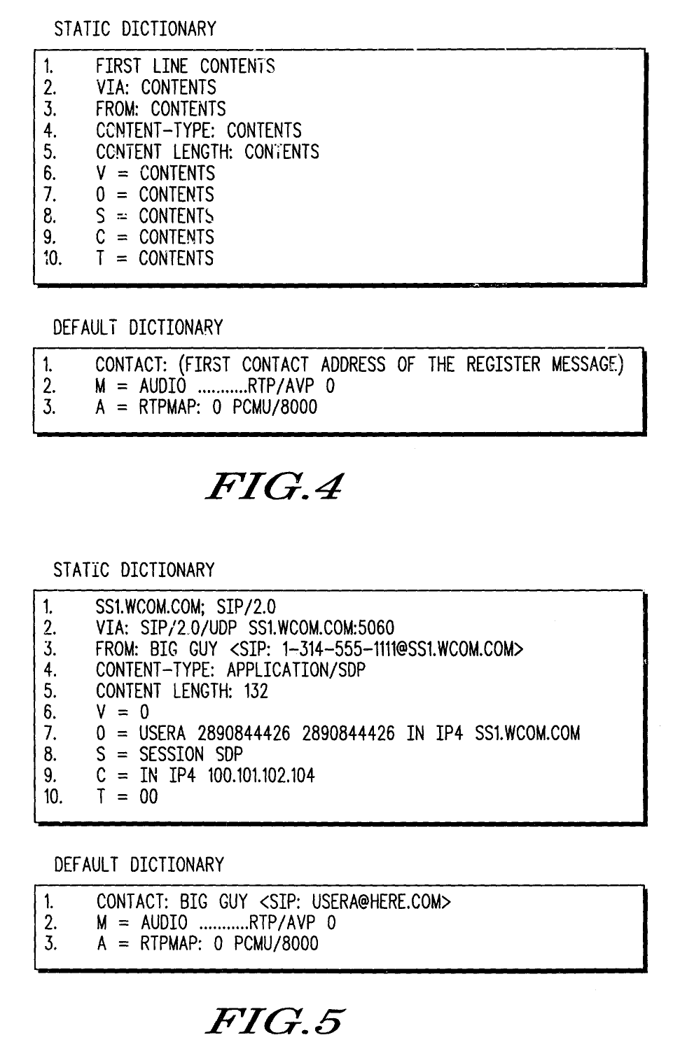

As previously stated, the static and default dictionary information is used by the MS 102 (138) and the SIP Agent 108 (124) to compress call setup messages for transmission over the air interface and to expand compressed messages received in the MS 102 (138) or SIP Agent 108 (124). The static and default dictionaries generated using the information in the Register Message of FIG. 3 are shown in FIG. 5. The static dictionary contains: 1) the contents of the first line (ss1.wcom.com; SIP/2.0); 2) the contents of the Via line (SIP/2.0/UDP ss1.wcom.com:5060); 3) the contents of the From line (BigGuy<sip:1-314-555-1111@ss1.wcom.com>); 4) the contents of the Content-Type line (application/SDP); 5) the contents of the Content-Length line (132); 6) the contents of the v line (0); 7) the contents of the o line (UserA 2890844426 2890844426 IN IP4 ss1.wcom.com); 8) the contents of the s line (Session SDP); 9) the contents of the c line (IN IP4 100.101.102.104); and 10) the contents of the t line (0 0). The default dictionary contains: 1) the first contact address in the Register message (BigGuy<sip:UserA@here.com>); 2) the first m line in the Register message less the port number (m=audio . . . RTP/AVP 0); and 3) the first a line in the Register message (a=rtpmap:0 PCMU/8000).

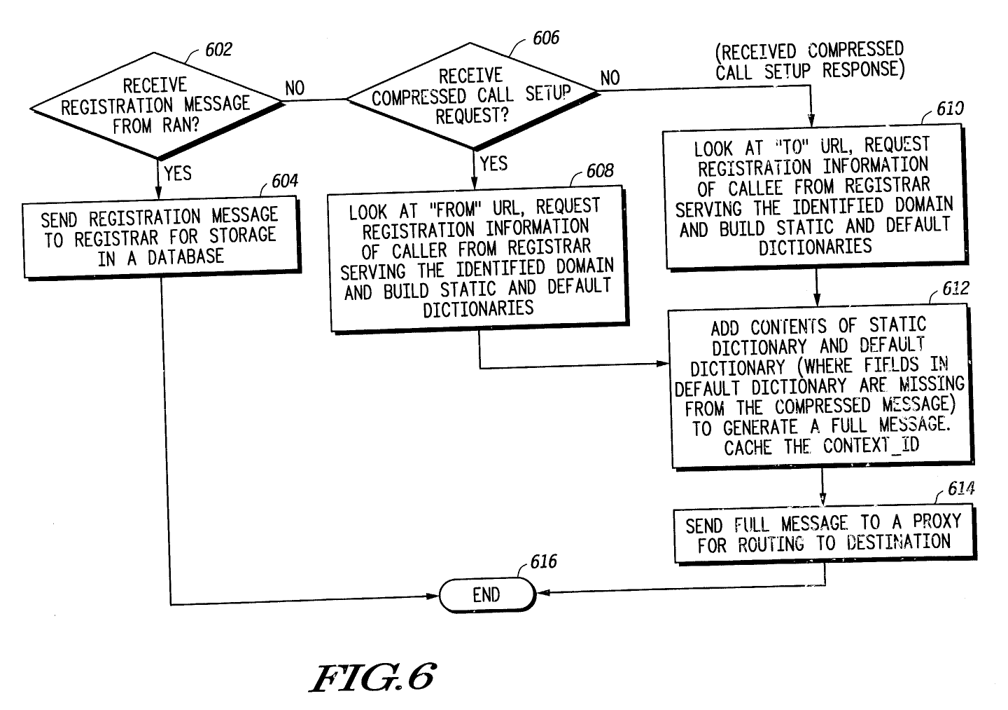

Referring back to FIG. 2, after the MS 102 (138) generates the static and default dictionaries, the Register Message is transmitted to the BTS 104 (136) in the RAN 103 (134) (step 208) and the method in the MS 102 (138) ends (step 220). The message is then transmitted to the SIP Agent 108 (124). Referring to FIG. 6, when the SIP Agent 108 (124) determines that the Register Message has been received (step 602), it forwards the message to the Registrar 110 (126) for storage in the database 116 (132) (step 604). At step 616, the method ends.

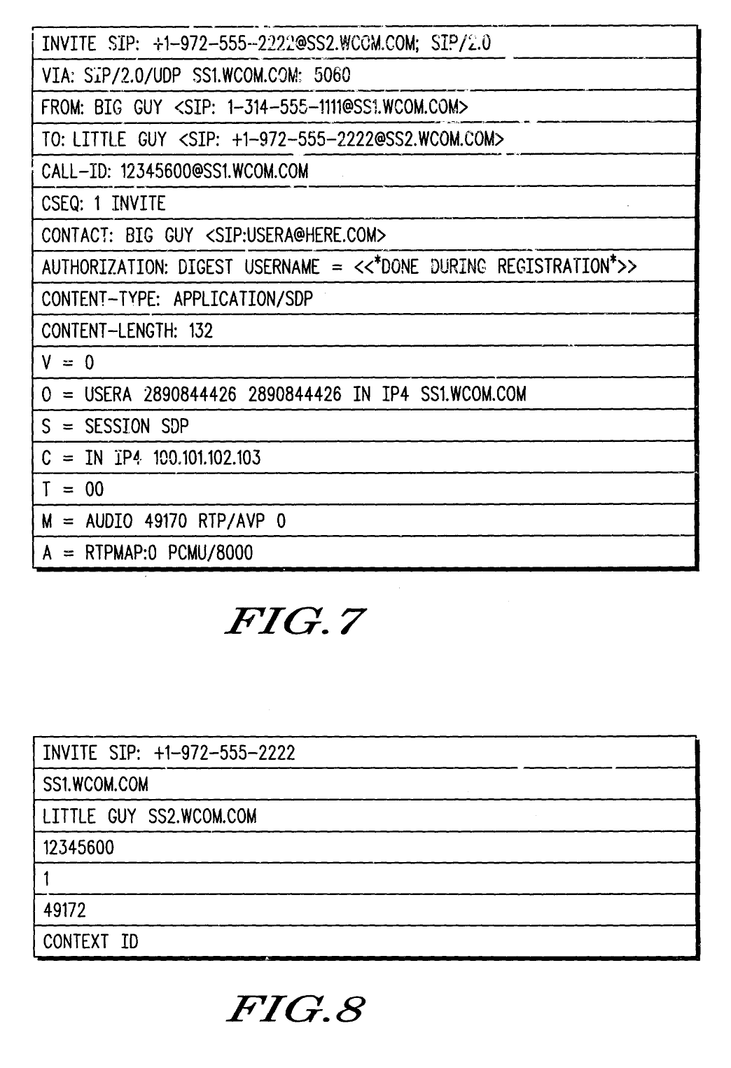

Once Registration is complete, call set up can take place. For purposes of the following call setup example it is assumed that both MSs 102 and 138 have registered with their respective CNs 106, 122 as shown in FIG. 1. MS 102 registered using the Register Message of FIG. 3 and MS 138 registered with the CN 122 using a different Register Message (not shown). It is further assumed that MS 102 desires to establish a session with MS 138. Referring back to FIG. 2, when the MS 102 desires to send a call set up message over the air interface to the BTS 104 (step 210), the MS 102 generates a full SIP message (step 212). From the full SIP message, the MS 102 generates a compressed SIP message by deleting information matching the contents of the MS's static and default dictionaries (step 214). The method of generating a compressed SIP message from a full SIP message in the MS will now be described using the example SIP INVITE message of FIG. 7. It will be recognized by one of ordinary skill in the art that the method can be used on any of a number of call set up messages.

Referring to FIG. 7, BigGuy (MS 102) is trying to establish a session with LittleGuy (MS 138). From the full INVITE message, the method of the present invention running in the MS 102 generates a compressed SIP INVITE message by deleting information in the full INVITE message that matches the contents of the MS's static and default dictionaries (step 214 in FIG. 2). Comparing FIG. 7 to the static and default dictionaries in FIG. 5, we see that “INVITE sip:+1-972-555-2222” (where INVITE is the method name and 1972-555-2222 is the telephone number of LittleGuy) is not included in the first line contents of the MS's static dictionary, so they are included in the compressed INVITE message. The URL of the MCI proxy server “ss2.wcom.com” is also not included in the first line contents of the MS's static dictionary. However, this information is included in the “To” line of the compressed INVITE message, so it is not included in the first line of the compressed message. The Via field in FIG. 7 matches the Via field in the static dictionary, so it is not included in the compressed SIP message. The From field in FIG. 7 matches the From field in the static dictionary. The URL in the From field is included in the compressed SIP message because the SIP Agent 108 uses this information to regenerate the full SIP message.

LittleGuy in the To field of the full INVITE message is not included in the static dictionary, so it is included in the compressed INVITE message. The URL in the To field is also included in the compressed message because, as will be seen later, the URL is used by the SIP Agent 124 to regenerate a response full SIP message. (Because the callee's telephone number has already been included in the first field of the compressed message, it is not repeated.) The Call-ID number of the Call-ID field of the full INVITE message is not in the static dictionary so it is included in the compressed INVITE message. The host URL “ss1.wcom.com” has already been included in the compressed INVITE message, so it is not repeated. The “Cseq” field of the full INVITE message contains the message name (INVITE) and a single decimal sequence number (1) chosen by the MS 102. Because the method name has already been specified in the first field of the compressed INVITE message, it is not repeated. The sequence number (1) is included in the compressed message because it states that the INVITE message is being sent for the first time. The “Contact” field information is stored in the default dictionary, so it is not included in the compressed INVITE message. (As described later herein, when the SIP Agent (108) receives the compressed INVITE message with no Contact specified, it will retrieve the default Contact information from the Registrar 110.) The next eight fields of the full INVITE message are included in the static dictionary, so they are not included in the compressed INVITE message. The m field less the port number is included in the default dictionary, so only the port number is included in the compressed INVITE message. The contents of the a field are included in the default dictionary, so they are not included in the compressed INVITE message. Finally, the method of the present invention generates a context ID in a known manner and appends the ID to the end of the message. The context ID is a unique identifier for the compressed SIP message. The resulting compressed INVITE message is shown in FIG. 8.

As shown in FIG. 8, the compressed INVITE message includes the method name (INVITE), LittleGuy's telephone number, LittleGuy's URL, LittleGuy's name, the Call-ID uniquely identifying the INVITE message, the sequence number of the INVITE message, the port number for the MS 102 where audio packets can be received, and the context ID uniquely identifying the compressed INVITE message. All other information in the full INVITE message is static or default information and has been stripped to yield the compressed INVITE message. The compressed INVITE message is transmitted over the air interface to the BTS 104 (step 216, FIG. 2) and the method ends (step 220, FIG. 2). The compressed INVITE message is forwarded by the BTS 104 to the core network 106. Specifically, the compressed INVITE message is transmitted to the SIP Agent 108. Referring to FIG. 6, when the SIP Agent 108 receives the message, it determines whether it is a call set up Request (step 606). If the answer is yes, at step 608, the Agent 108 looks at the URL in the From line of the message and requests the cached information of the caller from the Registrar serving the identified domain. Upon receiving the cached information, the SIP Agent (108) populates the static and default dictionaries. In the current example, the identified domain of the caller is “ss1.wcom.com.” The Registrar serving that domain is Registrar 110 as shown in FIG. 1. At step, 612, the SIP Agent 108 adds the contents of the static dictionary and default dictionary (where one or more fields in the default dictionary are missing from the compressed message) to generate the full INVITE message shown in FIG. 7. At step 614, the Agent 108 sends the full message to a Proxy 112a for routing to the Internet 118. At step 616, the method ends. Referring back to step 606, if the received message is a call set up Response, the Agent 108 looks at the URL in the To line of the message, requests the cached information of the callee from the Registrar/Location server serving the identified domain and populates the static and default dictionaries using the information (step 610). The Agent 108 continues processing at step 612 as previously discussed.

Details of step 612 will now be discussed. In constructing the full INVITE message from the compressed INVITE message, the SIP Agent 108 identifies information that is missing from the compressed INVITE message and retrieves the missing information from the populated static and default dictionaries. First, the SIP Agent 108 retrieves “; SIP/2.0” from the first line of the static dictionary and appends it to the first line of the compressed INVITE message to produce the first line of the full INVITE message. Next, the SIP Agent 108 inserts the Via and From fields from the static dictionary into the full INVITE message. Next, the SIP Agent inserts the remainder of the To field from the static dictionary into the full INVITE message. Next, the SIP Agent 108 appends the caller's URL to the Call-ID to complete the Call-ID field of the full INVITE message. Next, the SIP Agent 108 appends the method name to the sequence number in the Cseq field to complete the Call-ID field of the full INVITE message. Next, the SIP Agent 108 retrieves the Contact field from the default dictionary and inserts it into the full INVITE message. Next, the SIP Agent 108 retrieves the Content-type, Content-Length, v, o, s, c and t fields from the static dictionary and inserts them into the full INVITE message. Finally, the SIP Agent 108 retrieves the m and a fields from the default dictionary and inserts them into the full INVITE message. To complete the m field, the SIP Agent 108 uses the port number included in the compressed INVITE message. The full INVITE message resulting from the construction is that shown in FIG. 7.

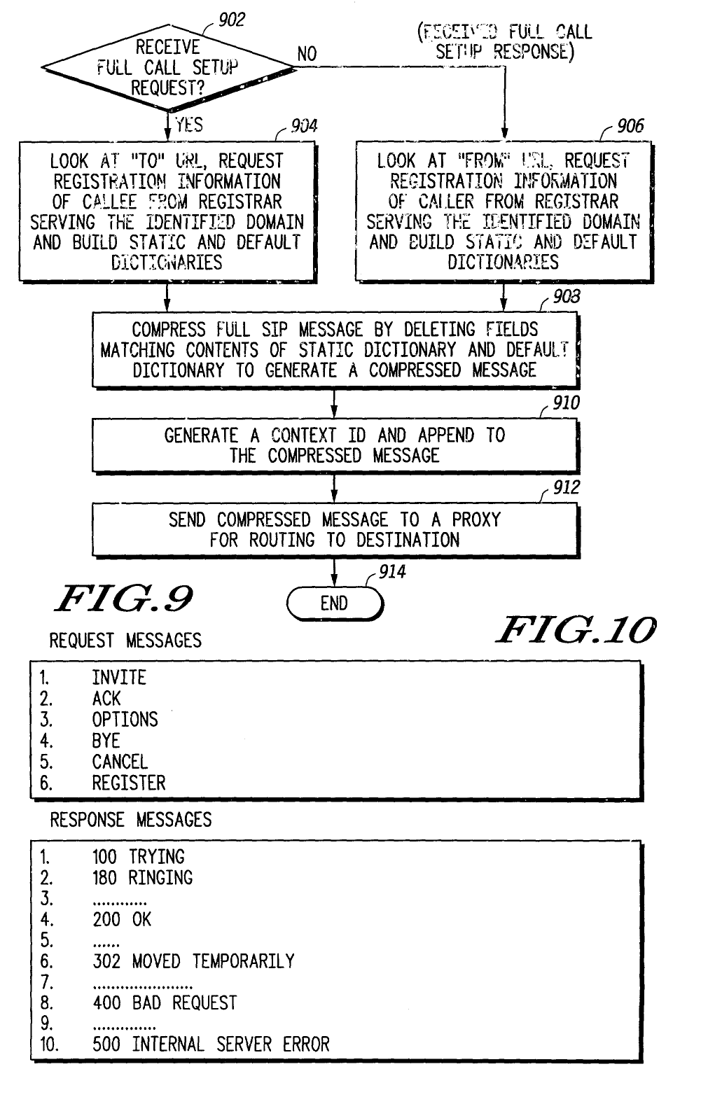

The full INVITE message is transmitted from the Internet 118 to the SIP Agent 124 in CN 122 for eventual downlink transmission to the MS 138. When the Agent 124 receives the full INVITE message, it compresses the message (as previously described with reference to the MS 102) for transmission over the air interface to the BTS 136. Referring to FIG. 9, the method of condensing a full setup message is shown. At step 902, the method determines whether a full call set up Request was received. If the answer is yes, at step 904, the method looks at the URL in the To field of the message and requests the cached information of the callee from the Registrar/Location Server Serving the identified domain. In the current example, the identified domain of LittleGuy is “ss2.wcom.com” and the Registrar serving that domain is Registrar 126. Upon receiving the cached information, the SIP Agent (124) populates the static and default dictionaries. At step 908, the SIP Agent 124 compresses the full INVITE message received from the Internet 118 by deleting fields matching the contents of the static and default dictionaries. At step 910, the SIP Agent 124 generates a context ID and appends it to the compressed message. At step 912, the SIP Agent 124 sends the compressed message to a Proxy 128 (FIG. 1) for eventual transmission to the BTS 136. At step 914, the method ends. Referring back to step 902, if a full call set up Response was received, at step 906, the method looks at the URL in the From field of the message, requests the cached information of the caller from the Registrar/Location Server Serving the identified domain to populate the static and default dictionaries, and continues processing at step 908 as previously described.

When the compressed message is received at the BTS 136, it is transmitted to the MS 138. From the compressed message, the MS 138 generates a full INVITE message as previously described with respect to the SIP Agent 108. Referring to FIG. 2, at step 218, the MS 138 adds the contents of its static dictionary and default dictionary (when default information is missing from the compressed message) to generate a full INVITE message. At step 220, the method ends.

Upon processing the INVITE message, the MS 138 will generate a Response (e.g., “200 OK” message) to transmit to the MS 102. In accordance with the method of FIG. 2, the MS 138 determines that it is needs to send a call set up message (step 210). At step 212, the MS 138 generates a full SIP Response and compresses the message at step 214. At step 216, the MS 138 transmits the compressed message over the air interface to the BTS 136 (FIG. 1) and the method ends (step 220). The BTS 136 transmits the compressed Response to the SIP Agent 124 in the CN 122. Upon receipt, the SIP Agent 124 generates a full Response from the compressed Response in accordance with the method of FIG. 6. This time, at step 606, the SIP Agent 124 determines that it received a compressed call set up Response. At step 610, the SIP Agent 124 looks at the URL in the To line of the message, requests cached information of the callee from the Registrar serving the identified domain. In the current example, the identified domain is “ss2.wcom.com” and the Registrar is Registrar 126. Upon receipt of the information, the SIP Agent 124 populates the static and default dictionaries. At step 612, the SIP Agent 124 adds the contents of the static dictionary and default dictionary (when one or more fields in the default dictionary are missing from the compressed message) to generate a full Response. At step 614, the SIP Agent 124 sends the full message to Proxy 128a for eventual routing to the Internet 118. At step 616, the method ends.

After processing by the Internet 118, the full Response is forwarded to the SIP Agent 108 in the CN 106. The SIP Agent 108 invokes the method of FIG. 9 to compress the full Response before transmitting it over the air interface to the RAN 103. Referring to FIG. 9, at step 902 the SIP Agent 108 determines that it received a call set up Response. At step 906, the SIP Agent 108 looks at the URL in the From field of the message, requests the cached information of the caller from the Registrar/Location Server Serving the identified domain, and populates the static and default dictionaries. In the current example, the identified domain is “ss1.wcom.com” and the Registrar serving that domain is Registrar 110. At step 908, the SIP Agent 108 compresses the full Response by deleting fields matching the contents of the static and default dictionaries. At step 910, the SIP Agent 108 generates a context ID and appends it to the compressed message. At step 912, the SIP Agent 108 sends the compressed Response to the Proxy 112a (FIG. 1) for eventual transmission to the BTS 104. At step 914, the method ends. Upon receipt of the compressed Response from the BTS 104, the MS 102 translates the message into a full Response in accordance with the method of FIG. 2 (as previously described).

The apparatus and method of the present invention provides a method of translating full SIP messages into shorter compressed SIP messages for transmission over an air interface. This significantly reduces the delay in setting up an RTP connection. The present invention also provides a means for translating the compressed messages back into full SIP messages for transmission to IP based networks (such as the Internet). The apparatus and method introduces a new element, a SIP agent, for translating the full Sip messages and compressed SIP messages using information cached during registration of a user device. The logic for generating the messages is contained in the SIP Agent and the user device (e.g. MS).

While the invention may be susceptible to various modifications and alternative forms, a specific embodiment has been shown by way of example in the drawings and has been described in detail herein. However, it should be understood that the invention is not intended to be limited to the particular forms disclosed. Rather, the invention is to cover all modification, equivalents and alternatives falling within the spirit and scope of the invention as defined by the following appended claims.

What is claimed is:

1. A method of generating a compressed message from a full message comprising the steps of:
receiving a full message;
retrieving a URL in a field of the message;
obtaining information corresponding to the URL from a database;
building static and default dictionaries from the information; and
deleting information in the full message that matches information in the static and default dictionaries to generate the compressed message.

2. The method of claim 1 wherein the full message is a Request downlink message and the step of retrieving a URL in a field of the message comprises retrieving the URL in the To field of the message.

3. The method of claim 1 wherein the full message is a Response downlink message and the step of retrieving a URL in a field of the message comprises retrieving the URL in the From field of the message.

4. The method of claim 1 further comprising the step of appending a context ID to the compressed SIP message.

5. A method of generating a compressed message from a full message in a mobile station that has registered with a network via a Register message, the method comprising the steps of:
generating a full message;
building static and default dictionaries containing information from the Register message; and
deleting information in the full message that matches the information in the static and default dictionaries to generate the compressed message.

6. A method of generating a full message from a compressed message comprising the steps of:
receiving a compressed message;
retrieving a URL in a field of the message;
obtaining information corresponding to the URL from a database;
building static and default dictionaries from the information;
adding information from the static dictionary to the information in the compressed message to produce an interim full message; and
adding information from the default dictionary to the interim full message to produce the full message.

7. The method of claim 6 wherein the step of adding information from the default dictionary comprises for each field in the default dictionary, adding the field to the interim full message only when the field is missing from the compressed message.

8. The method of claim 6 wherein the compressed message is a Request uplink message and the step of retrieving a URL in a field of the message comprises retrieving the URL in the From field of the message.

9. The method of claim 6 wherein the compressed message is a Response uplink message and the step of retrieving a URL in a field of the message comprises retrieving the URL in the To field of the message.

10. A method of generating a full message from a compressed message in a mobile station that has registered with a network, the method comprising the steps of:
receiving a compressed message;
retrieving registration information from a static dictionary and a default dictionary;
adding information from the static dictionary to the information in the compressed message to produce an interim full message; and
adding information from the default dictionary to the interim full message to produce the full message.

11. The method of claim 10 wherein the step of adding information from the default dictionary comprises for each field in the default dictionary, adding the field to the interim full message only when the field is missing from the compressed message.
